(19) United States
(12) Patent Application Publication
(10) Pub. No.: US 2024/0308877 A1
(43) Pub. Date: Sep. 19, 2024

(54) Water Filtration System

(71) Applicants: Teena Kulakowski, Conway, NH (US); Russell Malley, Conway, NH (US)

(72) Inventors: Teena Kulakowski, Conway, NH (US); Russell Malley, Conway, NH (US)

(21) Appl. No.: 18/183,376

(22) Filed: Mar. 14, 2023

(51) Int. Cl. C02F 1/00; B01D 24/48

(52) U.S. Cl. CPC C02F 1/001; B01D 24/48; B01D 2101/04; C02F 2201/005; C02F 2307/14

(57) ABSTRACT

A water filtration system is provided. Generally, the filtration system is usable with well water to remove contaminants such as metals, among many other components. The filtration system utilizes a granular filter medium, such as, for example, washed sand. The water filtration also includes a multi way backwash system that allows cleansing of the filter medium by passing backwash water in a first clockwise direction as well as an opposite counter clockwise direction. This rocks the filter medium back and forth by the backwash fluid flow, providing improved cleansing of the filter medium as well as better overall filter operation.

### BACKGROUND OF THE INVENTION

The present disclosure relates generally to water filtration systems. More particularly the present disclosure relates to a device to filter residential water, typically from well water, which has two backwash modes to cleanse the filtration material allowing for long life of the filtration device with low maintenance costs and effort.

Many residences, particularly those in more rural and suburban areas, utilize a well as a source of potable water. In many instances, even when the water is of drinkable quality, it may often contain substantial amounts of additional elements including metals such as iron, and other minerals. These can cause problems with, for example, scaling on pipes, faucets, shower heads, and the like, as well as staining of toilet bowls, baths, sinks, plates, and the like. Moreover, excessive minerals are not desirable for drinking in many cases, where pure water is desired. Excess iron in many cases can cause health issues, for example. Other minerals such as phosphorous can cause water to have an offensive taste and odor.

Currently, complex filtration systems are utilized to filter and purify water. These systems are expensive and use filtration devices, such as filters, which are rapidly fouled and must be replaced frequently, further adding to costs. These complex systems also generally must be installed and maintained by professionals, which even further drives up costs. These costs can make clean water inaccessible for many, who instead must accept the low-quality water in their homes.

Therefore, what is needed is a simple and low-maintenance system for providing clean water.

### SUMMARY OF THE INVENTION

The subject matter of this application may involve, in some cases, interrelated products, alternative solutions to a particular problem, and/or a plurality of different uses of a single system or article.

In one aspect, a water filtration system and device is provided. The device has a water inlet, water outlet, backwash control section, and filtration section. The water inlet is typically connected to a water source, such as a residential water source, and typically, but not always, a well water source. The water outlet is connected to a source of potable water, typically, but not always, a water inlet or water main to a residence. The backwash control section has four valves. These four valves are operable to control a backwash flow from the water inlet to a backwash outlet (washout line) in both a counterclockwise flow direction, and a clockwise flow direction (depending on valve open/close orientation) with backwash water leaving the filtration device through the backwash outlet washout line. The filtration comprises an outer pipe or similar housing containing a quantity of granular filter medium. a porous pipe such as a well point is positioned within the granular filter medium, such that a water from the water inlet flows through the filter medium, into the porous pipe as filtered water, and to a water outlet.

In another aspect, a method of cleansing a filter medium in a water filtration system having a granular filter medium is provided. The method involves closing an outlet valve of a filtered water outlet of the water filtration system. Next, a backwash valve may be opened to direct flow out of a washout line for backwashed fluid. After this, a first backwash flow is directed using valve configuration in a direction opposite to a filtration flow direction to cleanse the filter medium. Next, a second backwash flow is directed in a direction parallel to the filtration flow direction again by adjusting at least one of a plurality of valve positions. This process may be repeated until the water runs clearly through an outlet line and the filter medium has been given sufficient time to be cleansed.

### BRIEF DESCRIPTION OF DRAWINGS

FIG. 1 provides a view of an embodiment of the present disclosure having valves configured in a filtration mode.

FIG. 2 provides a view of an embodiment of the present disclosure having valves configured in a counter-clockwise backwash mode.

FIG. 3 provides a view of an embodiment of the present disclosure having valves configured in a clockwise backwash mode.

FIG. 4 provides a partial exploded view of an embodiment of the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a water filtration system with a dual backwash system to cleanse the filter after a period of use. The filtration system utilizes sand or other negatively buoyant materials as the filter medium to treat water coming from a water source. Typically, though not always, the water source is a well, and the destination of the water is a residence. Of course, the system may be used in other configurations without straying from the scope of this disclosure. Importantly, the system utilizes a dual backwash configuration which can run water from the water source in two opposite directions through the filter. This dual direction backwash “rocks” the granular filter medium back and forth, disrupting and dislodging the filtered contents back into the water and to a waste outlet. Repeated rocking back and forth agitation of the filtration medium using the backwash system contemplated herein allows for a cleaning and nearly indefinite reusability of the filtration system and filter medium therein.

The water filtration system is formed generally by a quantity of piping, valves and a granular filtration medium. Typically, the piping is water grade plastic piping such as PVC, CPVC, PEX, and the like. Of course, any material such as a metal, other plastic, composite, and the like that are capable of withstanding operational water pressure may be used as well without straying from the scope of this disclosure. Valves may be any valve capable of stopping and allowing fluid flow through the piping. Typically, the valve is a ¼ turn shut off valve, like a ball valve and the like. Of course, any other valve or shut-off configuration may be used without straying from the scope of this disclosure. The filter medium is a granular and negatively buoyant material such that it is denser than the water it is intended to filter. In one embodiment, the filter medium is sand, particularly washed sand. However, the filter medium may be any negatively buoyant material which operates to filter water passing therethrough when arranged in the filter bed as discussed below. Other examples of filter material include, but are not limited to sand, gravel, crushed rock, granules of charcoal or the like, stainless steel balls, stainless steel beads, metallic balls, metallic beads, glass beads, plastic beads, filled polymeric beads, glass balls, metallic balls coated with a polymeric material, metallic beads coated with a polymeric material, and polymeric beads filled with a suitable material such as calcium, and combinations thereof.

An important inventive feature of the present invention is the dual direction backwash system. In the prior art, a backwash is used to cleanse the filter and allow it to have continued life without replacement of the filter. However, a simple reverse flow backwash causes the water to have to pass all the way through the filter medium before reaching the most fouled area of the filter which is closest to the inlet of the filter. This backwashing method, when used in a granular filter medium system such as this disclosure, ends up just packing the filter medium down towards the inlet end, and drives even more of the filtered content down towards the inlet side. In sum, a simple reverse flow backwash system is not adequate for proper cleansing of the filter medium. The present disclosure solves this problem by a dual-direction back wash system. This agitates and moves around the filter medium, rocking it back and forth to dislodge the filtered material. It also ensures backwashing water is directly flowing into all sides of the filtration medium. By controlling flow using valve positioning, the backwash flow can be run in a reverse direction, then a forward direction, and alternating between forward and reverse a number of times until an adequate cleansing of the filtration material has been achieved.

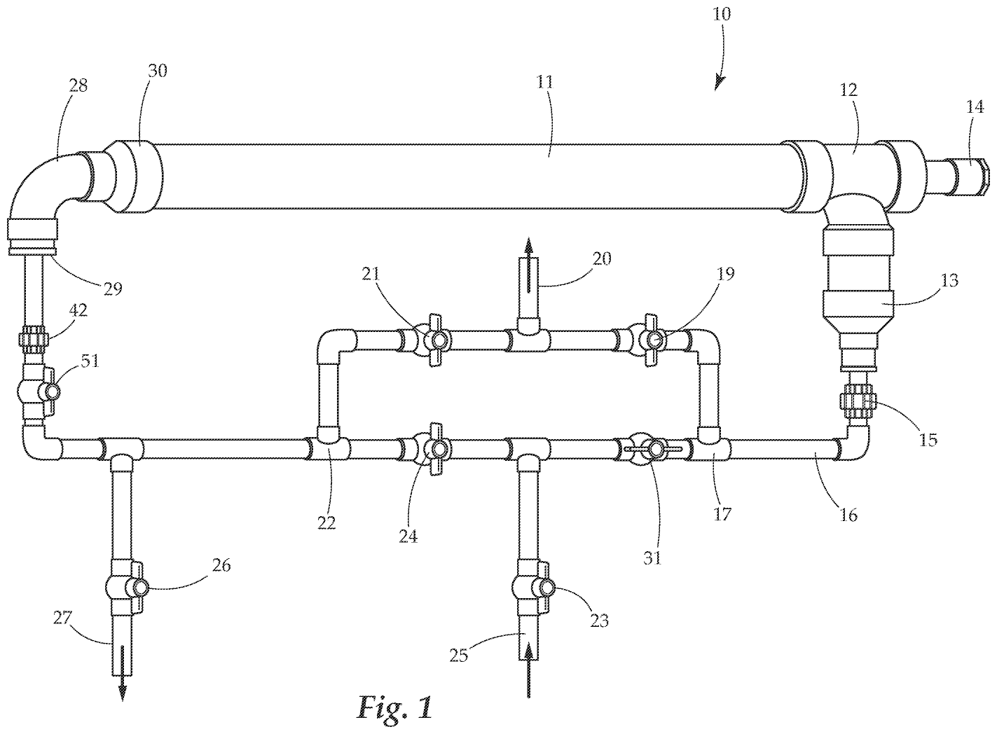

Turning now to FIG. 1 an embodiment of the filtration having the valves set in an operational water filter mode is shown. The filtration system 10 has a filtration section 11 formed of a length of piping. Inside this filtration section 11 is the filter medium (not shown) as well as a porous internal pipe (not shown) for receiving the filtered water. In typical embodiments, the porous internal pipe is a well point, though other similarly configured devices may be used without straying from the scope of the present disclosure. Water to be filtered enters the filtration section 11 through sweep T 12. The opposite end of the sweep T 12 is closed with plug 14 which may be removed to allow access to internal components and add/remove filter medium. The water passes through the filter medium (not shown) and then into the well point (not shown) after being filtered. Water then exits the filtration section 11 via reducer 30, elbow 28, and reducer 28 which together with the well point operate to contain the granular filter medium. Water then flows through valve 26 and out of water outlet 27 which may connect to, for example, a water connection of a residence, among other things. Shut off valve 51 is positioned next to union 42 which allows a user to disconnect the filtration and pipe the inlet water directly to the outlet by closing valve 31, opening valve 24, and closing shut off valve 51. In typical embodiments of operation, the filtration section 11 is filled to approximately the bottom of sweep T 12, which allows the filter medium to have some space for movement during a backwash process to better dislodge filtered material from the filter medium.

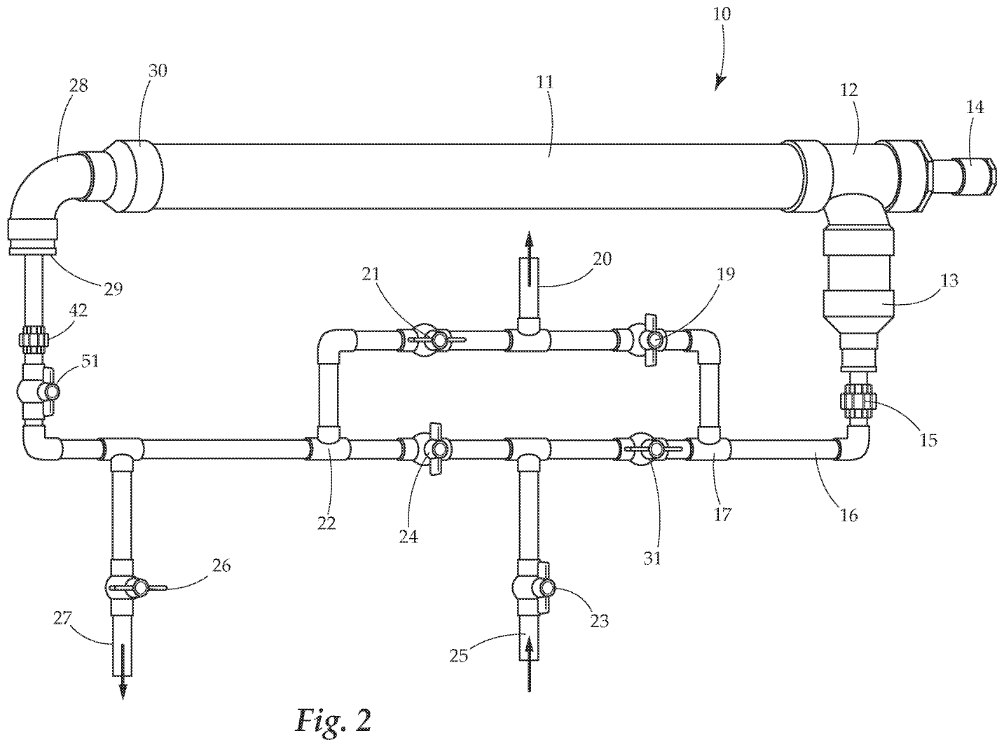

Referring to FIGS. 1-3, On an inlet flow side of the filtration system 10, water enters from, for example, a well via inlet 25 and through valve 23. In the filtration configuration shown in FIG. 1, water flows from the inlet directly to the piping 16, union 15, and reducer 13 into the sweep T 12 and then the filtration section 11. Also, on the inlet flow side region of the filtration system 10, there is a series of piping and valves which allow for multiple different flow directions and configurations. These structures work together to provide the dual-direction backwash operation. Water inlet 25 splits in two directions at T and can pass through valve 31 or 24. In the counter-clockwise or forward backwash mode, as seen in FIG. 2, valve 31 is open as is valve 21, while the outlet water valve 26 is closed, blocking the water outlet and valve 19 is also closed. This valve configuration causes water to flow through the filtration system and then out of the washout line 20 in a counter clockwise direction as shown in FIG. 2.

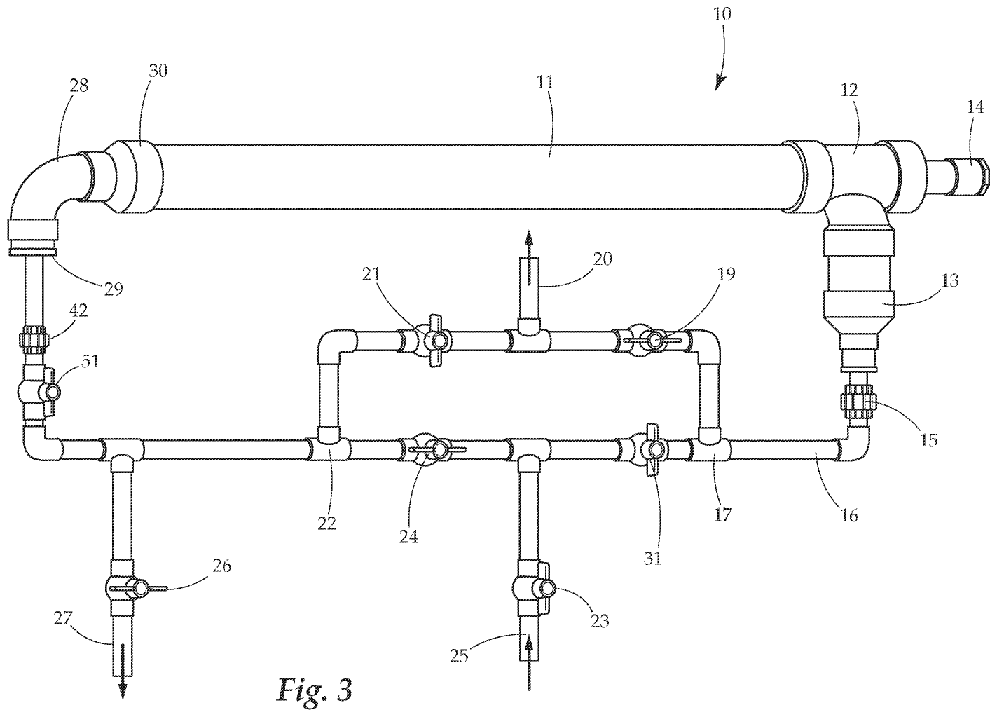

Turning to FIG. 3, a clockwise or reverse flow backwash mode of valve configuration is shown. Here, valve 26 is closed to block the water outlet 27, as is valve 31 and valve 21. Valves 24 and 19 are open, which causes water from the inlet 25 to travel up through the reducers 29 and 30, in a backwards direction compared to the filtration mode and counter clockwise backwash mode of FIGS. 1 and 2 respectively. In operation, a user may alternate between a clockwise backwash flow, and then a counter clockwise backwash flow. This has the distinct advantage of “rocking,” churning, or otherwise disrupting the filter medium by way of the back and forth backwash flow. This not only dislodges the filtered material from the filter to cleanse it, but also evenly distributes the filter medium throughout filtration section 11 piping, preventing it from being overly packed or settled in one direction or another. Overly packed sections can reduce flow rate, increase pressure drop, and cause the water to find alternative paths through the filtration section which can lead to improper filtration.

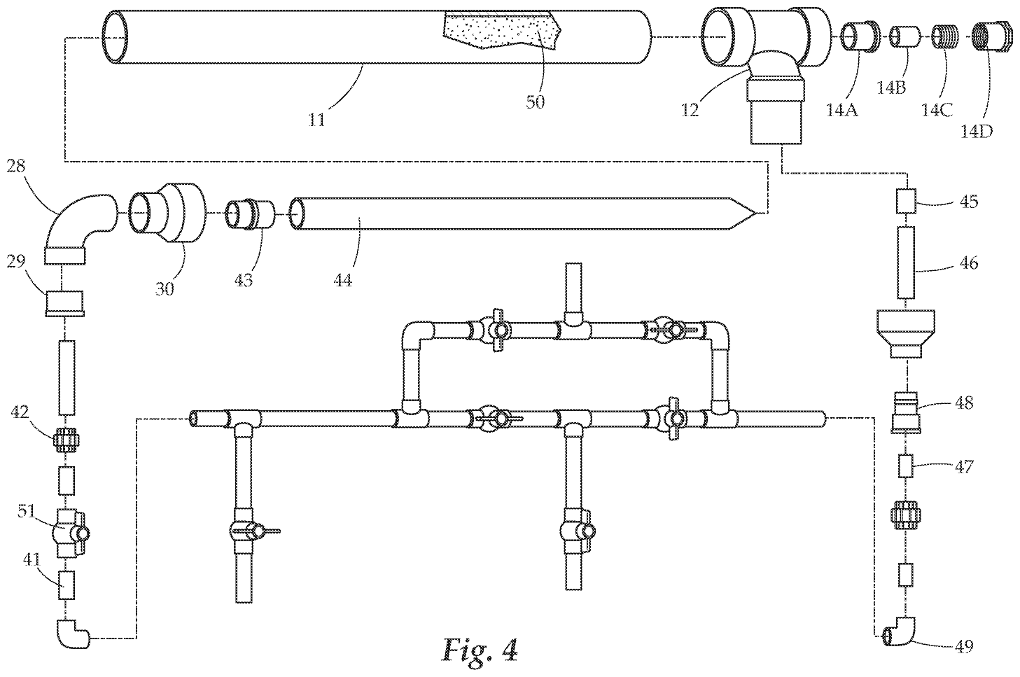

FIG. 4 provides an exploded view of an embodiment of the water filtration portion of the system of the present disclosure. Inside the water filtration section piping 11 is a porous tube or pipe, in this embodiment shown as a well point 44. In testing, it has been shown that the ratio of a 4″ piping for the filtration section 11 relative to a 2″ well point provides effective filtration at common residential water flow rates. The well point is approximately 41″ long which again provides a significant length for filtration along the length of the filtration section 11. This ratio of length and width has been seen to provide unexpectedly improved filtration relative to pressure drop. At least partially, and preferably fully surrounding the well point 44 is the filter medium 50, shown in this embodiment as sand. A 2″ male to male slip joins the end of the well point to an inner diameter of the reducer 30 allowing water to pass through the sand 50, into the well point 44, out the open end of the well point 44 into the slip and then to the elbow 28, reducer 29, union 42 and then outlet pipe via path 41.

On an inlet side of the filtration section 11, water from the water source such as a well enters through inlet 25 (as shown in FIGS. 1-3), passes through 1″ elbow and union 15, 2″ to 1″ reducer 47, 2″ slip 48, 4″ to 2″ reducer 13 and out through a 2″ well point 46 (or equivalent porous pipe) along the length of the well point 46 which allows for an even distribution of the water into the filtration material. The opening of the well point 46 is capped with 2″ cap 45. The end plug 14 comprises a reducer, in this embodiment a 4″ to 2″ reducer 14A, a pipe portion 14B, a 2″ threaded slip 14C and a 2″ threaded cap 14D. Depending on embodiment, filter material may also be on the inside of the sweep T 12, or may be contained within the filtration section piping 11.

When installed, it is important that the filtration system have its valve section accessible to a user, such as a residential homeowner. The water inlet, in one embodiment, is connected to a water main to a residence from a well water source. The water outlet is also piped into the water main of the residence. In a particular embodiment, the valves may be color coded or otherwise patterned, marked, labeled, or the like to indicate if the valve relates to water flow or backwash configuration. In a particular embodiment, the water inlet and outlet valves 26, 23, as well as the valve leading to flow towards inlet piping 16 are all blue, indicating the clean water flow. Meanwhile in this embodiment backwash control valves 19, 21, and 24 are red, indicating that operational flow of the water is stopped. Accordingly, when any blue valve is closed, the filtration system will not be in an operational mode. The four backwash operation valves 19, 21, 24, and 31 are arranged in a rectangle for easy visual indication of system operation. A user may have the diagonal valves in the same direction (open or closed) so as to control backwash flow direction. The rectangular orientation makes it easy to remember that diagonal valves are supposed to be in the same direction which helps with ease of use of the system. For example it can be seen in FIGS. 2 and 3 that valves 19 and 24 have the same orientation and valves 21 and 31 have the same orientation. When performing a backwash operation, the user initially may close outlet valve 26. Then the user can perform the backwash operation, alternating between one direction and another (counterclockwise to clockwise, or clockwise to counter clockwise). Depending on extent of filter fouling, this process may be repeated a number of times. Effectiveness of the backwashing can be visually confirmed by viewing the status of the water coming out of the washout line 20. If it is running clear, then the backwash process is nearly or completely done. Once completed, the valves may be returned to the operational mode as seen in FIG. 1. In a preferred embodiment, the first backwash direction will be a “clockwise” direction which is in a reversed direction to water flow in the filtration mode. This is because after a time, the filtration mode water flow will settle the filtration media in one direction, and the reverse flow provides force in an opposite direction to release the media and trapped filtered material. A user may then reverse the backwash to the counter clockwise direction, and then again to the clockwise reversed-direction backwash to further cleanse the filter media.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A water filtration device comprising:
a water inlet;
a backwash control section comprising four valves, the four valves operable to control a backwash flow from the water inlet in a counterclockwise flow direction, and a clockwise flow direction with backwash water leaving the filtration device through a washout line;
a filtration section comprising an outer pipe containing a quantity of granular filter medium, and having a porous pipe within the granular filter medium, such that a water from the water inlet flows into filter medium, into the porous pipe as filtered water, and to a water outlet.

2. The water filtration device of claim 1 wherein the valves are positioned in a filtration mode to pass water from the water inlet, through the filter medium, to a water outlet, such that a first valve is open to allow water flow from the water inlet to enter to a filtration side of the filtration section, and such that a remaining three valves are closed to prevent water flow in a non filtration direction and to prevent flow to the washout line.

3. The water filtration device of claim 1 wherein the valves are positioned in a clockwise backwash mode to cause water to flow in a direction reverse to a filtration direction from the water inlet through the filter medium via the porous pipe, and to the washout line, such that a first valve is closed to prevent water flow from the water inlet to enter a filtration side of the filtration section, a second valve controlling flow from the water inlet is in an open position to cause water to flow to a filtered side of the filtration section, a third valve is closed to prevent water flow directly from the water inlet to the washout line, and a fourth valve controlling flow to the washout line on the filtration side of the filtration section is open, allowing water to flow through the filter medium in the direction reverse to the filtration direction and out of the washout line.

4. The water filtration device of claim 1 wherein the valves are positioned in a counterclockwise backwash mode to cause water to flow in a same direction as a filtration direction from the water inlet through the filter medium, into the porous pipe, and to the washout line, such that a first valve is open to allow water flow from the water inlet to enter a filtration side of the filtration section, a second valve controlling flow from the water inlet opposite to the first valve via a T is in a closed position, a third valve is open allowing water to flow from the filtered side of the filtration section to the washout line, and a fourth valve controlling flow to the washout line on the filtration side of the filtration section is closed.

5. The water filtration device of claim 1 wherein the pipe of the filtration section is a 4 inch pipe.

6. The water filtration device of claim 5 wherein the porous pipe of the filtration section is a 2 inch pipe surrounded by the granular filter medium.

7. The water filtration device of claim 6 wherein the water inlet and water outlet are both 1 inch pipe.

8. The water filtration device of claim 1 wherein the filter medium is a washed sand.

9. The water filtration device of claim 1 wherein the filter medium is a negatively buoyant material.

10. The water filtration device of claim 1 wherein the water inlet is connected to a well water source.

11. The water filtration device of claim 10 wherein the outlet is connected to a residential water main.

12. The water filtration device wherein the four valves are positioned above ground.

13. A house comprising a water filtration device of claim 1.

14. The water filtration device of claim 1 wherein the porous pipe is a well point.

15. The water filtration device of claim 1 where handles of two of the four valves have a first color to indicate a first backwash flow, and handles of the other two of the four valve have a second different color to indicate a second backwash flow.

16. The water filtration device of claim 1 further comprising a second porous pipe at an inlet to the filtration section, the second porous pipe having an open end in communication with the water inlet, allowing water to flow out of the openings in the second porous pipe and into the filter medium.

17. The water filtration device of claim 1 wherein the porous pipe has a plurality of openings along its length, wherein the openings have a size which is less than a diameter of the filter medium to prevent the filter medium from entering the porous pipe.

18. A method of cleansing a filter medium in a water filtration system having a granular filter medium comprising:
closing an outlet valve of a filtered water outlet of the water filtration system;
opening a backwash valve to direct flow out of a washout line for backwashed fluid;
directing a first backwash flow in a direction opposite to a filtration flow direction;
directing a second backwash flow in a direction parallel to the filtration flow direction after the step of directing the first backwash flow by adjusting at least one of a plurality of valve positions.

19. The method of claim 18 further comprising the step of directing a third backwash flow in a direction opposite to a filtration flow direction after the step of directing the second backwash flow.

20. The method of claim 19 further comprising the step of stopping the backwash process when a water flow through the washout line runs clear, and opening the outlet valve of the filtered water outlet and closing the backwash valve.
